(19) United States
(12) Patent Application Publication
(10) Pub. No.: US 2017/0262459 A1
(43) Pub. Date: Sep. 14, 2017

(54) LOCATION PERSISTENCE IN A HISTORIAN SYSTEM

(71) Applicant: Invensys Systems, Inc., Foxboro, MA (US)

(72) Inventors: Stephane Bischoff, Quebec (CA); Patrice Huot, Quebec (CA)

(73) Assignee: Invensys Systems, Inc., Foxboro, MA (US)

(21) Appl. No.: 15/068,846

(22) Filed: Mar. 14, 2016

(51) Int. Cl. G06F 17/30; H04W 4/02

(52) U.S. Cl. CPC G06F 17/3087; H04W 4/02; G05B 2219/31368

(57) ABSTRACT

Persisting a location of a data source in an industrial process historian system. By persisting location data for state indicators, the state indicators are filtered based on a location corresponding to a remote device. The historian system permits transmitting state indicators to a remote device based on a location of the remote device relative to persisted location data associated with one or more process devices.

### BACKGROUND

Aspects of the present invention generally relate to the fields of networked computerized industrial control, automation systems, networked computerized systems utilized to monitor, log, and display relevant manufacturing/production events and associated data, and supervisory level control and manufacturing systems. More particularly, aspects of the present invention relate to systems and methods for persisting location data corresponding to process control devices in a historian system. Aspects of the present invention also relate to systems and methods for filtering state indicia of process control devices based on location data.

Historian systems capture and/or historize data about continuous processes, such as production status, performance monitoring, quality assurance, tracking, and product delivery. The historian system data can be accessed via remote devices, such as a smartphone or a tablet computing device. Conventional systems and methods rely on a human (e.g., an operator, a user, etc.) to manually search for data corresponding to particular process devices based on a name of the process device within the historian system. Reliance on manually entered searches leads to inefficient process management due to the requirement for the user to know the name of a particular process unit within the historian system.

### SUMMARY

Aspects of the invention persist a location of a data source in a historian system to facilitate filtering state indicia including the data source based on a location of a remote user device.

In an aspect, a historian system includes a historian data server adapted to store one or more data values and geolocation metadata associated with the data values. The data values represent a state of a process unit within a continuous process and the location metadata represents a geolocation of the process unit. The historian system also includes an engine communicatively coupled to the historian data server and adapted to generate state indicia, which corresponds to a location attribute including the geolocation metadata, based on the data values. And the historian system includes a state indicia server communicatively coupled to the engine. The state indicia server is adapted to store the generated state indicia in a memory storage device and receive a query from a remote user device via a communication network. The query includes a current geolocation of the remote user device. The state indicia server is further adapted to transmit the stored state indicia to the remote user device via the communication network in response to receiving the query when the current geolocation of the remote user device matches the location attribute of the state indicia.

A method embodying aspects of the invention provides a dynamic graphical representation of a process unit state within a continuous process. The method includes receiving, by a server computing device, one or more data values from a process unit within a continuous process adapted to generate the data values. The data values represent a state and geolocation of the process unit. The method also includes generating, by an engine of the server computing device, a dynamic graphical representation of the process unit state based on the data values and providing, by the server computing device, the dynamic graphical representation to the remote user device via a communication network. The dynamic graphical representation includes a location property comprising the geolocation of the process unit and the server computing device provides it in response to a request from the remote user device such that the remote user device filters the dynamic graphical representation based on the location property and a spatial proximity parameter relative to a current geolocation of the remote user device.

In another aspect, a method of distributing tag value alert notifications to a user device via a communication network includes receiving, by a server, a tag from a historian system via a communication network. The server comprises a processor and a memory storage device and the tag comprises a plurality of data values representing a state of a process unit within a continuous process and a location of the process unit. The method further includes storing the received tag and an alert configuration corresponding to a remote user on the memory storage device. The alert configuration comprises a proximity radius relative to a user device associated with the remote user and a threshold value corresponding to at least one of the plurality of data values representing the state of the process unit. The method also includes receiving, by the server, a current location of the user device over the communication network and transmitting, by the server, an alert notification over the communication network to the user device when a distance between the location of the process unit and the current location of the user device is within the proximity radius and the data value exceeds the threshold value. Reception of the alert notification causes the user device to display the alert notification and access the tag stored on the memory storage device over the communication network.

Other objects and features will be in part apparent and in part pointed out hereinafter.

### BRIEF DESCRIPTION OF THE DRAWINGS

FIG. 1 illustrates an exemplary architecture of a historian system according to an embodiment of the invention.

FIGS. 2 and 3 are flow diagrams illustrating exemplary operations of the system of FIG. 1.

FIG. 4 illustrates an exemplary display of state indicia and a filtering icon displayed by a graphical user interface according to an embodiment of the invention.

FIG. 5 is a flow diagram illustrating an exemplary alert notification operation of the system of FIG. 1.

FIG. 6 illustrates an exemplary display of an alert notification by a graphical user interface according to an embodiment of the invention.

FIG. 7 is a flow diagram illustrating an exemplary offline operation of the system of FIG. 1.

Corresponding reference characters indicate corresponding parts throughout the drawings.

### DETAILED DESCRIPTION

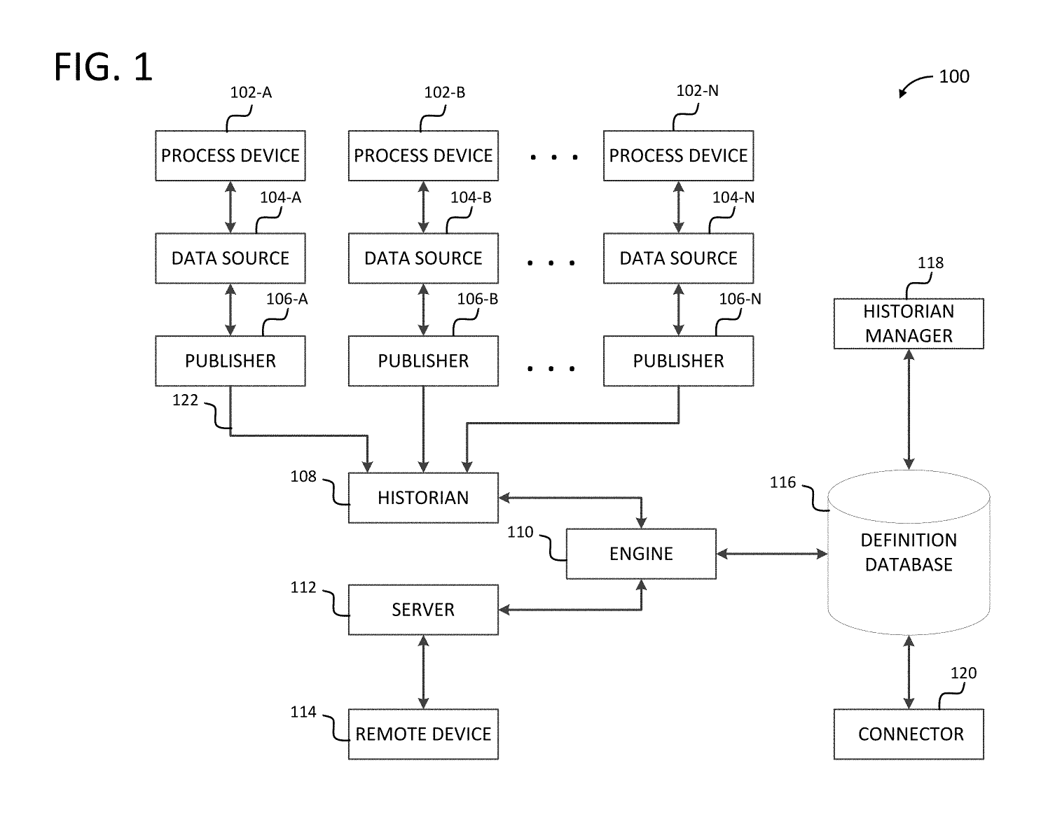

FIG. 1 illustrates an exemplary system, generally indicated at 100, within which an embodiment of the invention may be incorporated. The system 100 includes process devices 102, data sources 104, historian publishers 106, a historian system 108, an engine 110, a server 112, a remote device 114, a definition database 116, a historian manager 118, and a connector 120. Aspects of system 100 are communicatively coupled via a communications infrastructure 122. In an embodiment, aspects of system 100 enable filtering of indicators of the states of the process devices 102 within a continuous process based on a location of the remote device 114 relative to the locations of the process devices 102. In another embodiment, location data associated with process devices 102 is persisted within the historian system 108 and the server 112 for later consumption by client applications, such as those executing on remote device 114.

In the embodiment illustrated by FIG. 1, process devices 102 are communicatively coupled to data sources 104, data sources 104 are communicatively coupled to historian publishers 106, historian publishers 106 are communicatively coupled to the historian system 108, historian system 108 is communicatively coupled to the engine 110, engine 110 is communicatively coupled the server 112 and the definition database 116, server 112 is communicatively coupled to the remote device 114, and definition database 116 is communicatively coupled to the historian manager 118 and the connector 120.

One or more of process devices 102 comprise, for example, a processing system adapted for changing or refining raw materials to create end products. Exemplary processes include, but are not limited to, those in the chemical, oil and gas, food and beverage, pharmaceutical, water treatment, and power industries. Such processes may include conveyers, power distribution systems, and/or processes or operations that cannot be interrupted. In an embodiment, process devices 102 are adapted to control and/or monitor aspects of a processing system. In an embodiment, process devices 102 are programmable logic controllers (PLC) that control and collect data from aspects of a processing system. And the data sources 104 are adapted to collect and store data regarding aspects of respective process devices 102. Exemplary data sources include, but are not limited to, InTouch, SQL, and ClearScada.

The historian publishers 106 of FIG. 1 are adapted to publish data from data sources 104 to historian system 108. In an embodiment, historian publisher 106-A fetches data, including data representing the location of process device 102-A, from data source 104-A. In another embodiment, historian publisher 106-A requests and receives the location of data source 104-A from a user. For example, the location of data source 104-A may be entered graphically via a map, text input, and the like. The location of process device 102-A may be a location within a plant, a location relative to other process devices, a geolocation (e.g., longitude and latitude), or the like. In an embodiment, the location of process device 102-A is static over a given time period and the upload of data corresponding to the location of process device 102-A from historian publisher 106-A to historian system 108 is optimized such that the location data is not sent on every upload of tag data.

The historian system 108 is adapted to store data received from historian publishers 106 and a location of each process device 102. Persisting the location data in this manner enables server 112 and/or remote device 114 to filter state indicia based on the location data. In an embodiment, historian system 108 stores location data as extended properties. For example, extended properties may be used to store metadata about tags and data sources 104. In another embodiment, historian system 108 indexes extended properties to facilitate searching of tags and/or the extended properties. Searching may be done within existing clients, such as the Browser Client in Wonderware® Online provided by Schneider Electric, for example. In another embodiment, a location property is configured within a state indicator that contains the location of the first process device 102 within the state indicator. The location may be changed via historian manager 118 and/or connector 120.

The engine 110 is adapted to generate state indicia representing a state of process devices 102. In an embodiment, engine 110 creates a dynamic graphical representation of the data generated by process devices 102 to indicate performance metrics of the process devices 102. An exemplary engine 110 is Wonderware® SmartGlance provided by Schneider Electric. In an embodiment, state indicia is referred to as a report.

The server 112 is adapted to store state indicators generated by engine 110 and allow access to the stored state indicators by remote device 114. In an embodiment, server 112 receives a query from remote device 114 that includes a location parameter. For example, the location parameter may be a current location (e.g., latitude and longitude) of remote device 114 or a location entered via a map, a text box, and the like (e.g., address, radius parameter, postal code, city, etc.). The server 112 filters the stored state indicators based on the location parameter of the query. In an embodiment, server 112 determines which state indicators include location data that is an exact match of the location parameter of the query. In another embodiment, server 112 determines which state indicators include location data that indicate location of a process device 102 being within a predetermined distance of the location parameter of the query (e.g., within a radial distance of 5 kilometers). In an embodiment, server 112 filtering state indicators based on the location parameter of the query reduces the amount of data returned to remote device 114 via communication infrastructure 122.

The remote device 114 is adapted to retrieve state indicators from server 112, receive alerts from server 112, and generate user interfaces including the state indicators. For example, remote device 114 may be a mobile computing device, a smartphone, a tablet computing device, a laptop computing device, a smartwatch computing device, or the like. In an embodiment, remote device 114 executes an application as further described herein. In another embodiment, remote device 114 includes a GPS antenna to provide a geolocation (e.g., latitude and longitude) of remote device 114.

The definition database 116 is adapted to store definitions of state indicators. In an exemplary embodiment, definitions stored by definition database 116 define a format of state indicators when displayed on remote device 114. In an embodiment, a state indicator is configured and uploaded to definition database 116 by historian manager 118. For example, historian manager 118 may be Wonderware® Online provided by Schneider Electric. In another embodiment, a state indicator is configured and uploaded to definition database 116 by connector 120. For example, connector 120 may be an on-premise tool (e.g., available on a computing device at and/or near the continuous process) that allows users to configure SmartGlance reports and upload them to a SmartGlance server (e.g., server 112).

The communications infrastructure 122 is capable of facilitating the exchange of data among various components of system 100. The communications infrastructure 122 in the embodiment of FIG. 1 includes one or more local area networks (LANs) that are connectable to other telecommunications networks, including other LANs or portions of the Internet or an intranet. The communications infrastructure 122 may be any telecommunications network that facilitates the exchange of data, such as those that operate according to the IEEE 802.3 (e.g., Ethernet) and/or the IEEE 802.11 (e.g., Wi-Fi) protocols, for example. In another embodiment, communications infrastructure 122 is any medium that allows data to be physically transferred through serial or parallel communication channels (e.g., copper, wire, optical fiber, computer bus, wireless communication channel, etc.). In an embodiment, communications infrastructure 122 comprises at least in part a process control network.

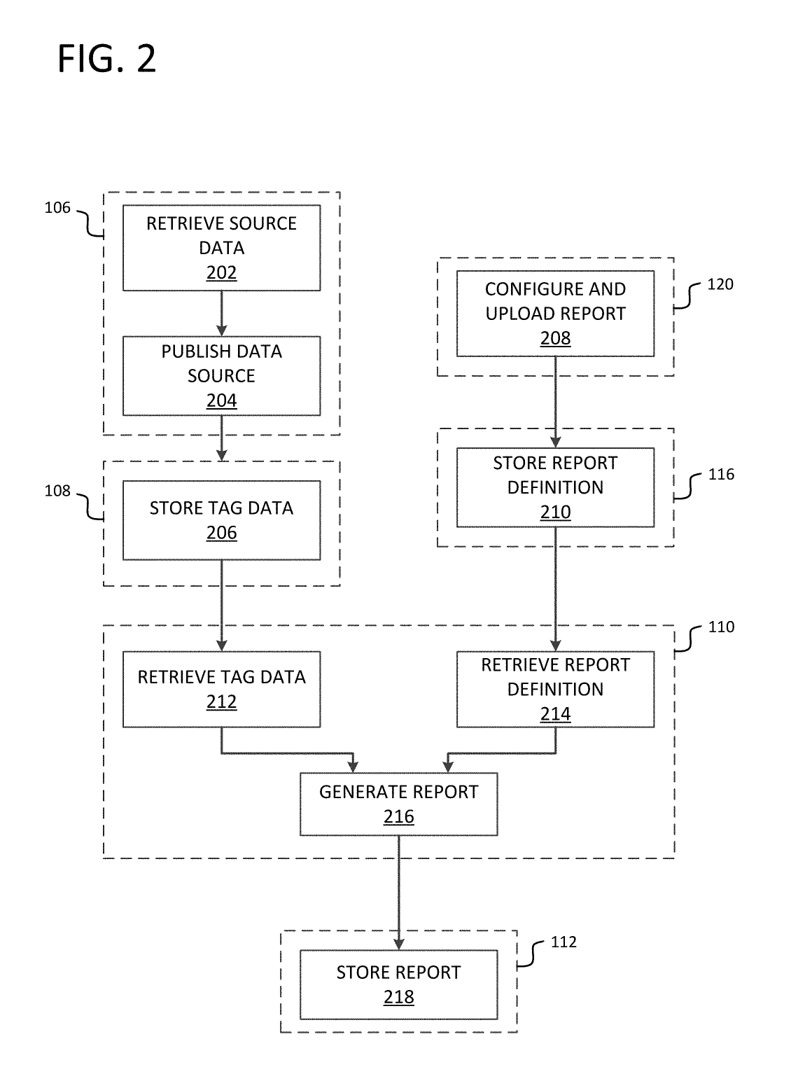

FIG. 2 illustrates an exemplary operation of aspects of system 100 in which a tag, including location data, is published to historian system 108 to generate a state indicator. At step 202, one of the historian publishers 106 retrieves data from one of process devices 102. The historian publisher 106 publishes the data to historian system 108 at step 204. The historian system 108 stores the published data as a tag at step 206. In an exemplary embodiment, the location data is stored as an extended property of the tag. At step 208, connector 120 uploads a configured state indicator to definition database 116. For example, a user may specify a format for a display of the state indicator using connector 120. The definition database 116 stores the state indicator definition at step 210. The engine 110 retrieves the tag data at step 212 and the state indicator definition at step 214 to generate a state indicator, including the location data, at step 216. In an embodiment, the location data is included as an attribute in the state indicator. In another embodiment, the location data is included as metadata of the state indicator. The engine 110 stores the generated state indicator, including the location data, on server 112 at step 218.

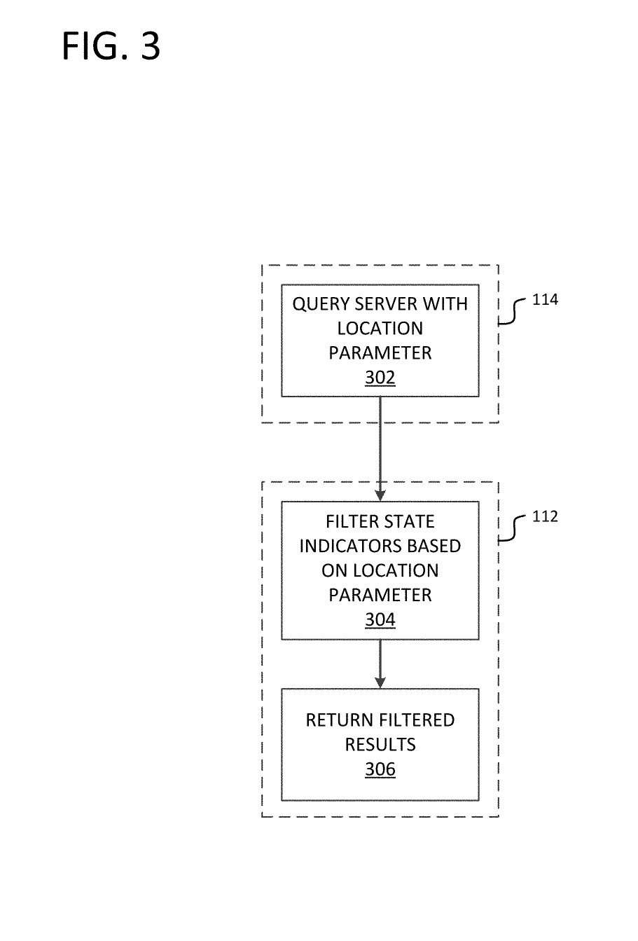

FIG. 3 illustrates an exemplary operation of aspects of system 100 in which a state indicator is filtered based on a location of remote device 114. At step 302, remote device 114 sends a query to server 112 that includes a location of remote device 114. In an embodiment, the location is a current geolocation (e.g., latitude and longitude) of the remote device 114, such as provided by a GPS system. In another embodiment, the location is a geolocation entered through a graphical user interface of the remote device, such as via a map, a text box, an icon, and the like. In yet another embodiment, the location is a current geolocation of the remote device 114, such as provided by a beacon associated with process devices 102 and/or a combination of a GPS system and a beacon. Exemplary beacons include those adapted to operate according to a short range wireless protocol, such as Bluetooth, to transmit signals. The server 112 filters the stored state indicators based on the location included with the query at step 304. For example, server 112 filters the stored state indicators based on the location as determined via a GPS system when a distance between the process device 102 and the remote device 114 is large (e.g., 10 kilometers) and as determined via a beacon and/or the GPS system when the distance is small (e.g., 100 meters), in accordance with an embodiment of the invention. Filtering state indicators based on the location as determined by a GPS system may be used to gather a rough value of the distance and the location as determined by a beacon and/or a combination of the GPS system and the beacon may be used to gather a more precise value of the distance. In an embodiment, the server 112 determines which state indicators have location data that matches the location of the query. For example, the match may be an exact match or may be within a certain radial distance from the location in the state indicator (e.g., the location of the associated process device 102). At step 306, server 112 returns to remote device 114 state indicators that have matching location data.

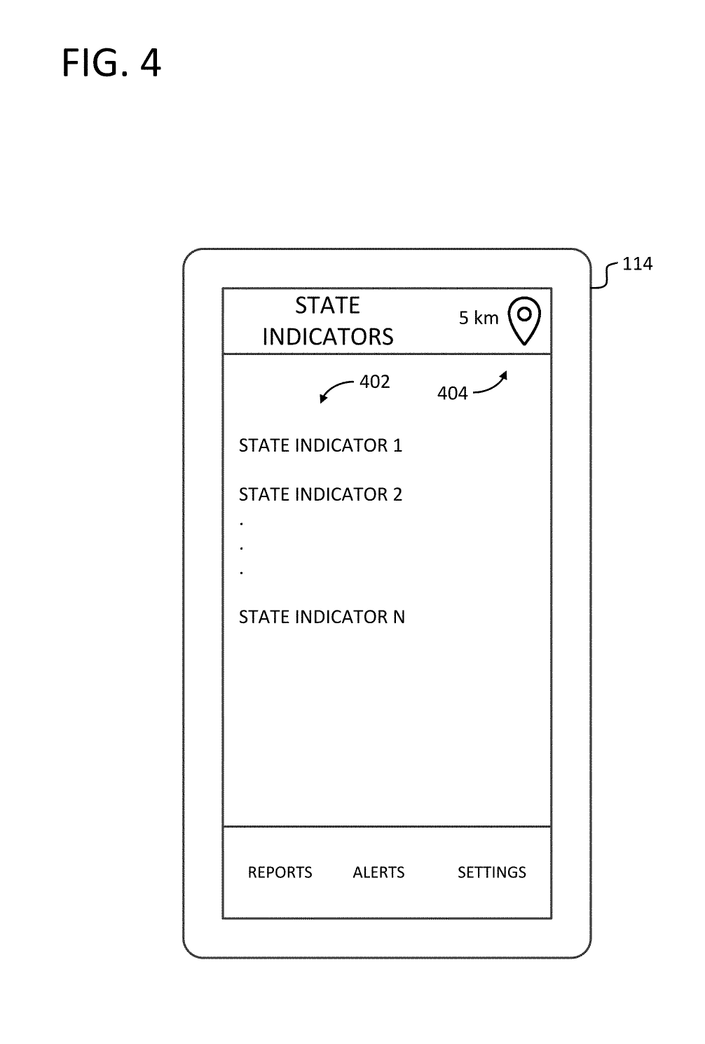

FIG. 4 illustrates an exemplary graphical user interface (GUI) display of an application executing on remote device 114. In the illustrated embodiment, the remote device 114 displays state indicators 402 that have been received from server 112 and a filtering icon 404. In an embodiment, selection (e.g., tapping a touchscreen, selecting with a mouse, etc.) of a state indicator 402 results in a graphical representation of tag values of the state indicator. In another embodiment, filtering icon 404 allows entry of location data for filtering state indicators. For example, filtering icon 404 allows selection of a search radius (e.g., kilometers, miles, etc.) such that all state indicators including data from process devices 102 within that radius relative to remote device 114 are retrieved from server 112. In another embodiment, filtering icon 404 allows entry of an address, a city, a postal code, or the like such that all state indicators including data from process devices 102 within the address, city, or postal code are retrieved from server 112. In yet another embodiment, selection of filtering icon 404 retrieves the state indicators from server 112 including data from process devices 102 that are closest to remote device 114 (e.g., top 10 closest results).

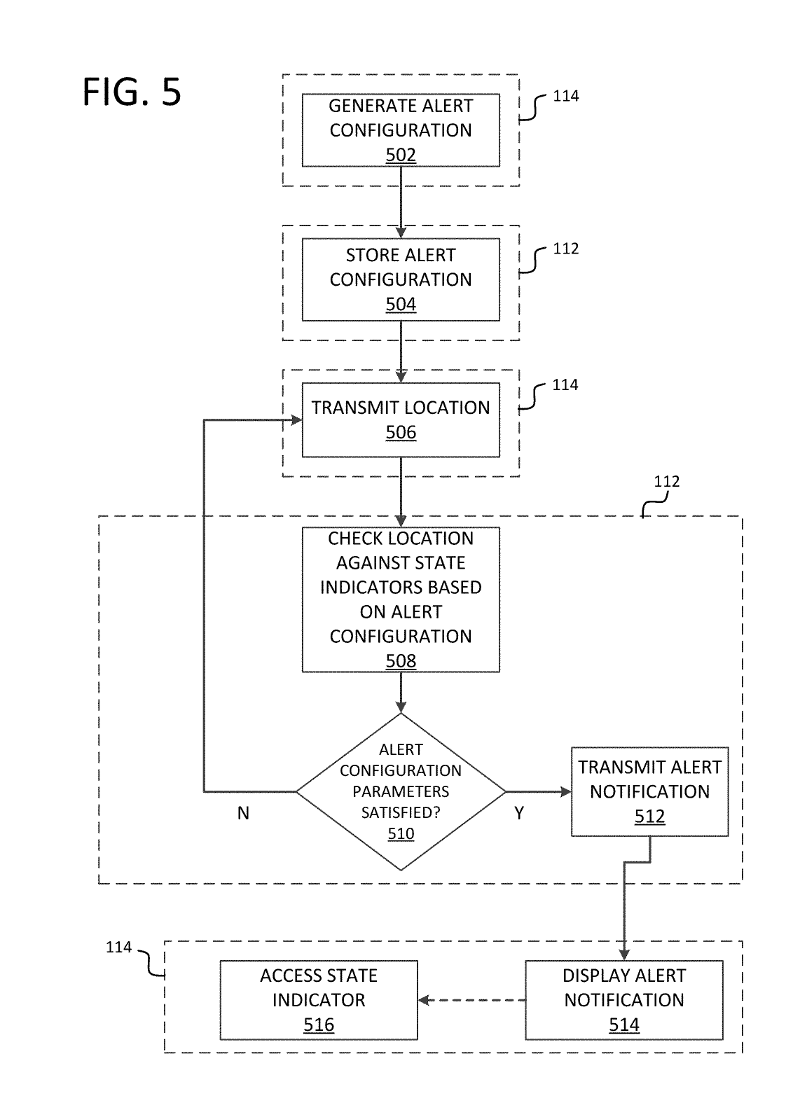

FIG. 5 illustrates an exemplary operation of aspects of system 100 in which an alert notification is sent to remote device 114 based on its location relative to one or more process devices 102. In this instance, the location of remote device 114 is relative to a location associated with a state indicator corresponding to a process device 102. At step 502, remote device 114 generates an alert configuration. In an embodiment, the alert configuration includes state indicators and a predetermined distance. At step 504, server 112 receives the alert configuration from remote device 114 and stores the alert configuration. The remote device 114 transmits a location at step 506. In an embodiment, remote device 114 transmits its current geolocation to server 112 at regular intervals. For example, remote device 114 may transmit its current geolocation at regular intervals when a certain application is active (e.g., opened). In another embodiment, remote device 114 transmits a geolocation to server 112 in response to a received command. In an embodiment, remote device 114 only transmits its location if a settings reflects that the location of remote device 114 can be tracked. At step 508, server 112 checks the received location of remote device 114 against the locations of the state indicators based on the alert configuration. For example, if the alert configuration includes a property that an alert should be sent when remote device 114 is within a certain distance (e.g., 1 kilometer), server 112 will check to see if any state indicators have locations that are within that distance of remote device 114. At step 510, server 112 determines whether any state indicators satisfy the alert configuration. In an embodiment, server 112 determines whether any state indicators have associated locations within the alert distance to remote device 114. In an additional and/or alternative embodiment, server 112 determines whether values of a state indicator satisfy the alert configuration (e.g., data meets or exceeds a threshold of the alert configuration). If the alert configuration parameters are satisfied, server 112 transmits an alert notification to remote device 114 at step 512. In an embodiment, in response to receiving the alert notification, remote device 114 displays an alert notification on the GUI at step 514. In another embodiment, in response to receiving the alert notification, remote device 114 accesses the state indicator associated with the alert notification on server 112 at step 516.

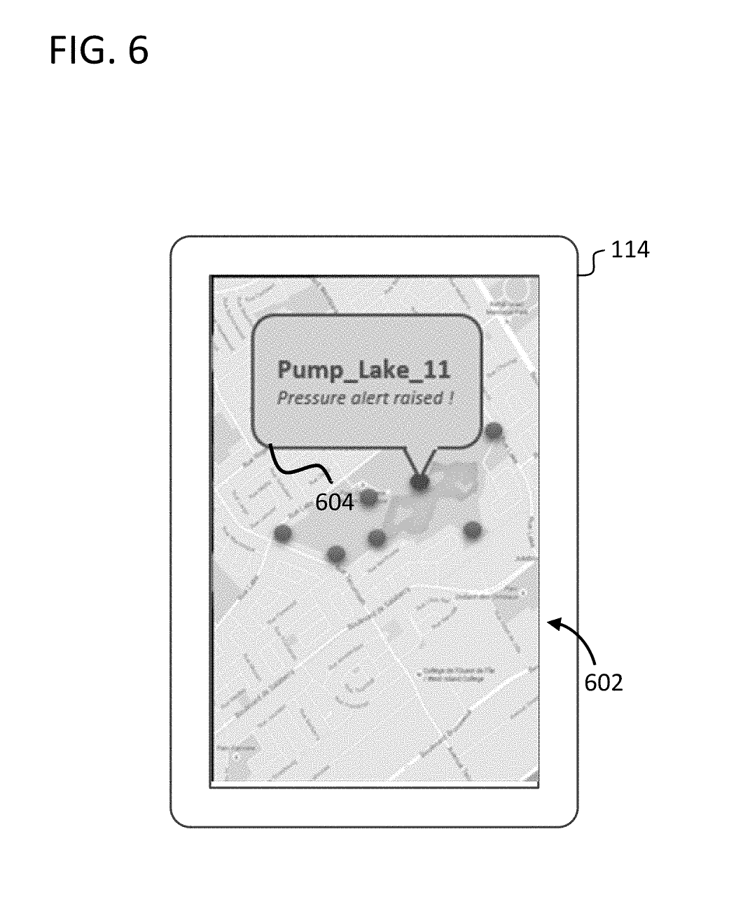

FIG. 6 illustrates an exemplary graphical user interface (GUI) display of an alert notification on remote device 114. In the illustrated embodiment, remote device 114 displays a map 602 and alert notification 604. The map 602 allows the alert notification 604 to be displayed relative to a location of remote device 114 and/or process devices 102. When the remote device 114 is within a proximity of a particular process device 102, the map 602 also allows alert notification 604 to be displayed when a state indicator affects the process device 102. In an embodiment, third-party map providers (e.g., Google Maps) are utilized to comprise map 602 and show all reports within a certain area. In another embodiment, map 602 is a diagram illustrating connections among process devices 102, such as those generated by SimSci provided by Schneider Electric. In the illustrated embodiment, alert notification 604 is a graphical bubble and text overlaid on map 602. In an embodiment, alert notification 604 may also comprise an audible signal emitted from remote device 114, a vibration of remote device 114, a badge displayed by remote device 114, and/or a banner displayed by remote device 114.

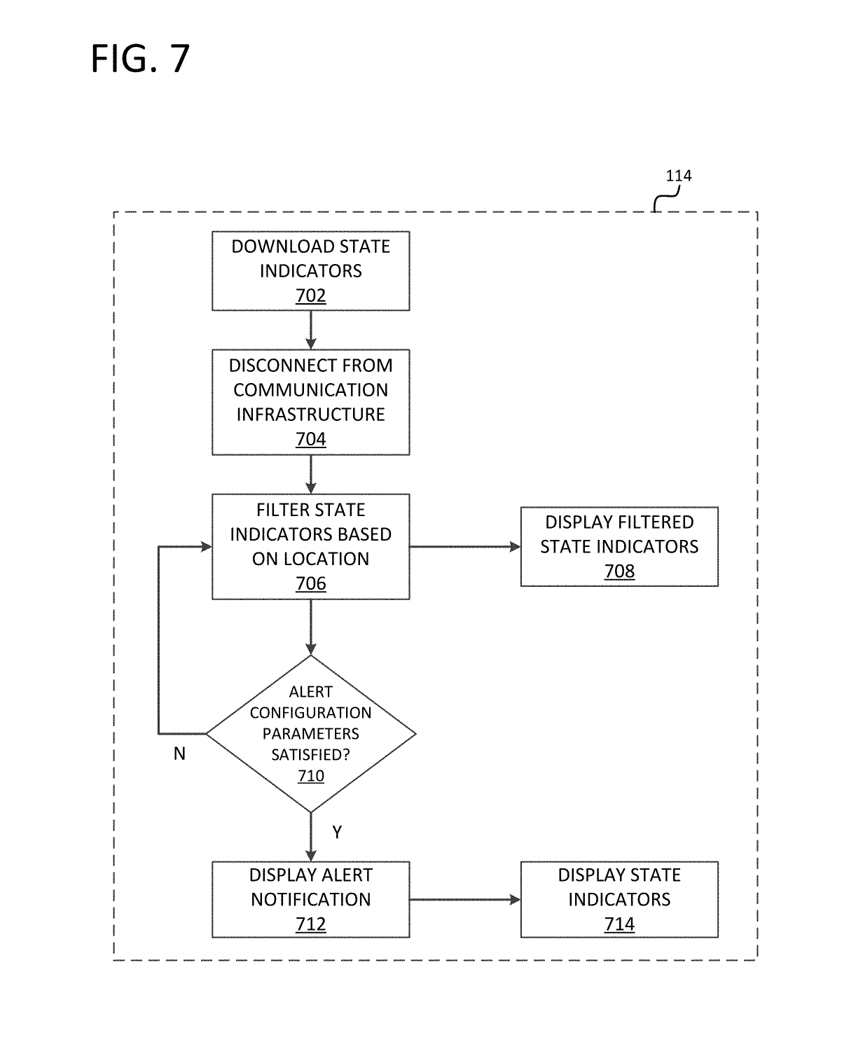

FIG. 7 illustrates an exemplary operation of aspects of system 100 in an offline mode, in which remote device 114 is decoupled from communication infrastructure 122. At step 702, remote device 114 downloads state indicators, including location data, from server 112. In an embodiment, remote device 114 accesses the state indicators over communications infrastructure 122 and stores the state indicators on a memory storage device of the remote device 114. The remote device 114 disconnects from communication infrastructure 122 (e.g., goes offline) at step 704. Although disconnected from the communication infrastructure, remote device 114 still has GPS or other location discovery capabilities (e.g. beacons that operate according to a short range wireless protocol, such as Bluetooth). At step 706, remote device 114 filters the stored state indicators based on a current location of the remote device. In an embodiment, remote device 114 displays the state indicators having location data that matches the current location or is within a specified distance of remote device 114 at step 708. For example, remote device 114 filters the stored state indicators based on the current location as determined via a GPS system when the specified distance is large (e.g., 10 kilometers) and as determined via a beacon and/or a GPS system when the specified distance is small (e.g., 100 meters), in accordance with an embodiment of the invention. In another embodiment, remote device 114 determines whether any state indicators satisfy an alert configuration stored on the remote device at step 710. In an embodiment, remote device 114 determines whether any state indicators have associated locations within an alert distance of the alert configuration to remote device 114. In an additional and/or alternative embodiment, remote device 114 determines whether values of a state indicator satisfy the alert configuration (e.g., data meets or exceeds a threshold of the alert configuration). If the alert configuration parameters are satisfied, remote device 114 displays an alert notification on the GUI, as further described herein, at step 712. In another embodiment, remote device 114 displays the state indicator associated with the alert notification at step 714.

Embodiments of the present invention may comprise a special purpose computer including a variety of computer hardware, as described in greater detail below.

Embodiments within the scope of the present invention also include computer-readable media for carrying or having computer-executable instructions or data structures stored thereon. Such computer-readable media can be any available media that can be accessed by a special purpose computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The following discussion is intended to provide a brief, general description of a suitable computing environment in which aspects of the invention may be implemented. Although not required, aspects of the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that aspects of the invention may be practiced in network computing environments with many types of computer system configurations, including personal computers, hand-held devices, multi-processor systems, microprocessor-based or programmable consumer electronics, network PCs, minicomputers, mainframe computers, and the like. Aspects of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing aspects of the invention includes a special purpose computing device in the form of a conventional computer, including a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory includes read only memory (ROM) and random access memory (RAM). A basic input/output system (BIOS), containing the basic routines that help transfer information between elements within the computer, such as during start-up, may be stored in ROM. Further, the computer may include any device (e.g., computer, laptop, tablet, PDA, cell phone, mobile phone, a smart television, and the like) that is capable of receiving or transmitting an IP address wirelessly to or from the internet.

The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The magnetic hard disk drive, magnetic disk drive, and optical disk drive are connected to the system bus by a hard disk drive interface, a magnetic disk drive-interface, and an optical drive interface, respectively. The drives and their associated computer-readable media provide nonvolatile storage of computer-executable instructions, data structures, program modules, and other data for the computer. Although the exemplary environment described herein employs a magnetic hard disk, a removable magnetic disk, and a removable optical disk, other types of computer readable media for storing data can be used, including magnetic cassettes, flash memory cards, digital video disks, Bernoulli cartridges, RAMs, ROMs, solid state drives (SSDs), and the like.

The computer typically includes a variety of computer readable media. Computer readable media can be any available media that can be accessed by the computer and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media are non-transitory and include, but are not limited to, RAM, ROM, EEPROM, flash memory or other memory technology, CD-ROM, digital versatile disks (DVD) or other optical disk storage, SSDs, magnetic cassettes, magnetic tape, magnetic disk storage or other magnetic storage devices, or any other medium which can be used to store the desired non-transitory information, which can accessed by the computer. Alternatively, communication media typically embody computer readable instructions, data structures, program modules or other data in a modulated data signal such as a carrier wave or other transport mechanism and includes any information delivery media.

Program code means comprising one or more program modules may be stored on the hard disk, magnetic disk, optical disk, ROM, and/or RAM, including an operating system, one or more application programs, other program modules, and program data. A user may enter commands and information into the computer through a keyboard, pointing device, or other input device, such as a microphone, joy stick, game pad, satellite dish, scanner, or the like. These and other input devices are often connected to the processing unit through a serial port interface coupled to the system bus. Alternatively, the input devices may be connected by other interfaces, such as a parallel port, a game port, or a universal serial bus (USB). A monitor or another display device is also connected to the system bus via an interface, such as video adapter 48. In addition to the monitor, personal computers typically include other peripheral output devices (not shown), such as speakers and printers.

One or more aspects of the invention may be embodied in computer-executable instructions (i.e., software), routines, or functions stored in system memory or non-volatile memory as application programs, program modules, and/or program data. The software may alternatively be stored remotely, such as on a remote computer with remote application programs. Generally, program modules include routines, programs, objects, components, data structures, etc. that perform particular tasks or implement particular abstract data types when executed by a processor in a computer or other device. The computer executable instructions may be stored on one or more tangible, non-transitory computer readable media (e.g., hard disk, optical disk, removable storage media, solid state memory, RAM, etc.) and executed by one or more processors or other devices. As will be appreciated by one of skill in the art, the functionality of the program modules may be combined or distributed as desired in various embodiments. In addition, the functionality may be embodied in whole or in part in firmware or hardware equivalents such as integrated circuits, application specific integrated circuits, field programmable gate arrays (FPGA), and the like.

The computer may operate in a networked environment using logical connections to one or more remote computers. The remote computers may each be another personal computer, a tablet, a PDA, a server, a router, a network PC, a peer device, or other common network node, and typically include many or all of the elements described above relative to the computer. The logical connections include a local area network (LAN) and a wide area network (WAN) that are presented here by way of example and not limitation. Such networking environments are commonplace in office-wide or enterprise-wide computer networks, intranets and the Internet.

When used in a LAN networking environment, the computer is connected to the local network through a network interface or adapter. When used in a WAN networking environment, the computer may include a modem, a wireless link, or other means for establishing communications over the wide area network, such as the Internet. The modem, which may be internal or external, is connected to the system bus via the serial port interface. In a networked environment, program modules depicted relative to the computer, or portions thereof, may be stored in the remote memory storage device. It will be appreciated that the network connections shown are exemplary and other means of establishing communications over wide area network may be used.

Preferably, computer-executable instructions are stored in a memory, such as the hard disk drive, and executed by the computer. Advantageously, the computer processor has the capability to perform all operations (e.g., execute computer-executable instructions) in real-time.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a”, “an”, “the” and “said” are intended to mean that there are one or more of the elements. The terms “comprising”, “including”, and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A historian system, comprising:
a historian data server adapted to store one or more data values and geolocation metadata associated therewith, wherein the data values represent a state of a process unit within a continuous process, and wherein the location metadata represents a geolocation of the process unit;
an engine communicatively coupled to the historian data server and adapted to generate state indicia based on the data values, wherein the state indicia corresponds to a location attribute including the geolocation metadata; and
a state indicia server communicatively coupled to the engine, the state indicia server adapted to:
store the generated state indicia in a memory storage device thereof,
receive a query from a remote user device via a communication network, said query comprising a current geolocation of the remote user device, and
transmit the stored state indicia to the remote user device via the communication network in response to receiving the query when the current geolocation of the remote user device matches the location attribute of the state indicia.

2. The system of claim 1, wherein the current geolocation of the remote user device matches the location attribute when the geolocation of the remote user device is within a predetermined distance from the geolocation of the process unit.

3. The system of claim 2, wherein the query includes the predetermined distance.

4. The system of claim 2, wherein the state indicia server is adapted to transmit an alert notification to the remote user device via the communication network when a distance between the geolocation of the process unit and the current geolocation of the remote user device is within the predetermined distance, wherein reception of the alert notification causes the remote user device to display the alert notification and access the state indicia of the process unit stored on the state indicia server via the communication network.

5. The system of claim 1, wherein the geolocation metadata is stored on the historian data server in a format common to other geolocation metadata stored on the historian data server.

6. The system of claim 1, wherein the geolocation metadata is stored on the historian data server as an extended property of a tag, the tag including the data values corresponding to the process unit.

7. The system of claim 1, further comprising a state indicia definition database communicatively coupled to the engine, the state indicia definition database comprising one or more state indicia definitions that define the generated state indicia.

8. The system of claim 1, further comprising a historian publisher communicatively coupled to the historian data server and adapted to upload a location property to the historian data server, the location property including the geolocation metadata.

9. A method of providing a dynamic graphical representation of a process unit state within a continuous process, comprising:
receiving, by a server computing device, one or more data values from a process unit within a continuous process adapted to generate the data values, wherein the data values represent a state of the process unit and a geolocation thereof;
generating, by an engine of the server computing device, a dynamic graphical representation of the process unit state based on the data values, wherein the dynamic graphical representation includes a location property comprising the geolocation of the process unit; and
providing, by the server computing device, the dynamic graphical representation to the remote user device via a communication network in response to a request from the remote user device such that the remote user device filters the dynamic graphical representation based on the location property thereof and a spatial proximity parameter relative to a current geolocation of the remote user device.

10. The method of claim 9, wherein the current geolocation of the remote user comprises a latitude and a longitude of the remote user device, and wherein the geolocation of the process unit comprises a latitude and a longitude of the process unit.

11. The method of claim 10, wherein the remote user device filters the dynamic graphical representation while disconnected from the communication network.

12. The method of claim 9, further comprising providing, by the server computing device, an alert notification to the remote user device via the communication network when the current geolocation of the remote user device is within a predetermined distance from the geolocation of the process unit, and wherein reception of the alert notification causes the remote user device to display the alert notification and access the dynamic graphical representation via the communication network.

13. The method of claim 9, further comprising storing the geolocation data values on a first memory storage device of the server computing device in a format common to other geolocation data representing a geolocation of one or more other process units stored on the first memory storage device.

14. The method of claim 13, further comprising storing the geolocation of the process unit on the first memory storage device as an extended property of a tag corresponding to the process unit, wherein the tag comprises the data values.

15. The method of claim 9, further comprising defining, by the server computing device, a format of the dynamic graphical representation and storing the format in a format database communicatively coupled to the server computing device, wherein the format represents a visual composition of the dynamic graphical representation on a graphical user interface display of the remote user device.

16. The method of claim 15, wherein generating the dynamic graphical representation comprises combining the data values into the dynamic graphical representation based on the format.

17. A method of distributing tag value alert notifications to a user device via a communication network, comprising:
receiving, by a server, a tag from a historian system via a communication network, the server comprising a processor and a memory storage device, the tag comprising a plurality of data values representing a state of a process unit within a continuous process and a location of the process unit;
storing the received tag on the memory storage device;
storing, on the memory storage device, an alert configuration corresponding to a remote user, wherein the alert configuration comprises a proximity radius relative to a user device associated with the remote user and a threshold value corresponding to at least one of the plurality of data values representing the state of the process unit;
receiving, by the server, a current location of the user device over the communication network; and
transmitting, by the server, an alert notification over the communication network to the user device when a distance between the location of the process unit and the current location of the user device is within the proximity radius and the data value exceeds the threshold value, wherein reception of the alert notification causes the user device to display the alert notification and access the tag stored on the memory storage device over the communication network.

18. The system of claim 17, wherein the location of the process unit comprises a combination of a latitude and a longitude of the process unit, and wherein the current location of the user device comprises a combination of a latitude and a longitude of the user device.

19. The system of claim 18, wherein reception of the alert notification causes the user device to display the alert notification on a map at the latitude and the longitude of the process unit.

20. The system of claim 17, wherein the tag data values representing the location of the process unit are stored on the memory storage device in a format common to tag data values representing a location of one or more other process units within the continuous process stored on the memory storage device.
